(19) United States
(12) Patent Application Publication
(10) Pub. No.: US 2025/0359509 A1
(43) Pub. Date: Nov. 27, 2025

(54) HANDLE HEIGHT ADJUSTER FOR WALK BEHIND MOWER

(71) Applicant: HUSQVARNA AB, Huskvarna (SE)

(72) Inventors: Claes LOSDAL, Jonkoping (SE); Reza TAJIK, Billdal (SE); Erik SKOOG, Huskvarna (SE)

(21) Appl. No.: 18/874,731

(22) PCT Filed: Dec. 16, 2022
(86) PCT No.: PCT/IB2022/062384

§ 371 Date: Dec. 13, 2024

(30) Foreign Application Priority Data
Jun. 15, 2022 (SE) 2250718-0

(51) Int. Cl. A01D 34/82; A01D 34/68; A01D 101/00

(52) U.S. Cl. CPC A01D 34/824; A01D 34/68; A01D 2101/00

(57) ABSTRACT

A lawn mower 10 may include a blade housing 12. an engine 14 supported at least in part by the blade housing 12. a handle assembly 18 operably coupled to the blade housing 12. and a handle height adjustment assembly (HHAA) 30 which may include a foot operated actuator 35 operably coupled to at least one handle member 20. The foot operated actuator 35 may be operably coupled to the at least one handle member 20 and spaced apart from a pivot point of the handle assembly 18 relative to the blade housing 12. The HHAA 30 may be configured to enable the at least one handle member 20 to be fixed in at least a first operating position or a second operating position defining different handle heights for the at least one handle member 20. The HHAA 30 may be further configured to enable the at least one handle member 20 to be rotated between the first operating position. the second operating position. and a folded position 60.

### TECHNICAL FIELD

Example embodiments generally relate to outdoor power equipment and, more particularly. relate to a walk behind lawn mower with an adjustable handle.

### BACKGROUND

Yard maintenance tasks are commonly performed using various tools and/or machines that are configured for the performance of corresponding specific tasks. Certain tasks, like grass cutting, are typically performed by lawn mowers. Lawn mowers themselves may have many different configurations to support the needs and budgets of consumers. Walk-behind lawn mowers are typically relatively compact, have comparatively small engines and are relatively inexpensive. Meanwhile, at the other end of the spectrum, riding lawn mowers, such as lawn tractors, can be quite large. Riding lawn mowers can sometimes also be configured with various functional accessories (e.g., trailers, tillers and/or the like) in addition to grass cutting components. Riding lawn mowers can also be ruggedly built and have sufficient power, traction, and handling capabilities to enable operators to mow over rough terrain, if needed. Walk behind models are often used when smaller lots or tighter areas are to be mowed. Some relatively simple walk behind models may move responsive only to the pushing force provided by the operator. However, other models may provide power to the wheels to assist the operator relative to providing mobility for the lawn mower. In either case, the operator typically controls the lawn mower and/or pushes the lawn mower via a handle assembly that extends rearward and upward behind the lawn mower to allow the operator to engage the handle assembly while walking behind the lawn mower.

It has long been appreciated that handle height adjustment can greatly improve the operator's comfort and therefore also enhance the operator experience while mowing. Accordingly, a great many solutions for providing handle height adjustment have been developed through the years. However, as improved materials and technologies become available, it should be expected that yet further advancements will come forward in this area.

### BRIEF SUMMARY OF SOME EXAMPLES

Some example embodiments may provide for a lawn mower. The lawn mower may include a blade housing configured to house at least one blade, an engine supported at least in part by the blade housing to selectively rotate the at least one blade, a handle assembly operably coupled to the blade housing, and a handle height adjustment assembly (HHAA) which may include a foot operated actuator operably coupled to the at least one handle member. The handle assembly may include at least one handle member for guiding operation of the lawn mower by an operator walking substantially behind the lawn mower. The foot operated actuator may be operably coupled to the at least one handle member at a portion of the at least one handle member that is spaced apart from a pivot point of the handle assembly relative to the blade housing. The HHAA may be configured to enable the at least one handle member to be fixed in at least a first operating position or a second operating position, each operating position defining different handle heights for the at least one handle member responsive to the HHAA being in a locked state. The HHAA may be further configured to enable the at least one handle member to be rotated between the first operating position, the second operating position, and a folded position responsive to the HHAA being in an unlocked state.

In an example embodiment, a handle height adjustment assembly (HHAA) for adjusting a height of at least one handle member of a walk-behind lawn mower may be provided. The HHAA may include a foot operated actuator operably coupled to the at least one handle member. The foot operated actuator may be operably coupled to the at least one handle member at a portion of the at least one handle member that is spaced apart from a pivot point of the handle assembly relative to the blade housing. The HHAA may be configured to enable the at least one handle member to be fixed in at least a first operating position or a second operating position, each operating position defining different handle heights for the at least one handle member responsive to the HHAA being in a locked state. The HHAA may be further configured to enable the at least one handle member to be rotated between the first operating position, the second operating position, and a folded position responsive to the HHAA being in an unlocked state.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a schematic view of a walk-behind lawn mower having a handle height adjustment assembly according to an example embodiment;

FIG. 2 illustrates a rear perspective view of the lawn mower and the handle height adjustment assembly according to an example embodiment;

FIG. 3 illustrates a side view of the lawn mower and the handle height adjustment assembly according to an example embodiment;

FIG. 4 illustrates a close up side view of the handle height adjustment assembly in a first operable position according to an example embodiment;

FIG. 5 illustrates a close up perspective view of the handle height adjustment assembly according to an example embodiment;

FIG. 6 illustrates a close up perspective view of the handle height adjustment assembly according to an example embodiment;

FIG. 7 illustrates a close up side view of a channel of the handle height adjustment assembly according to an example embodiment;

FIG. 8 illustrates an isolated perspective view of the handle assembly and the handle height adjustment assembly according to an example embodiment;

FIG. 9 illustrates an isolated top view of the handle assembly and the handle height adjustment assembly according to an example embodiment; and

FIG. 10 illustrates a close up view of the positioning guide according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

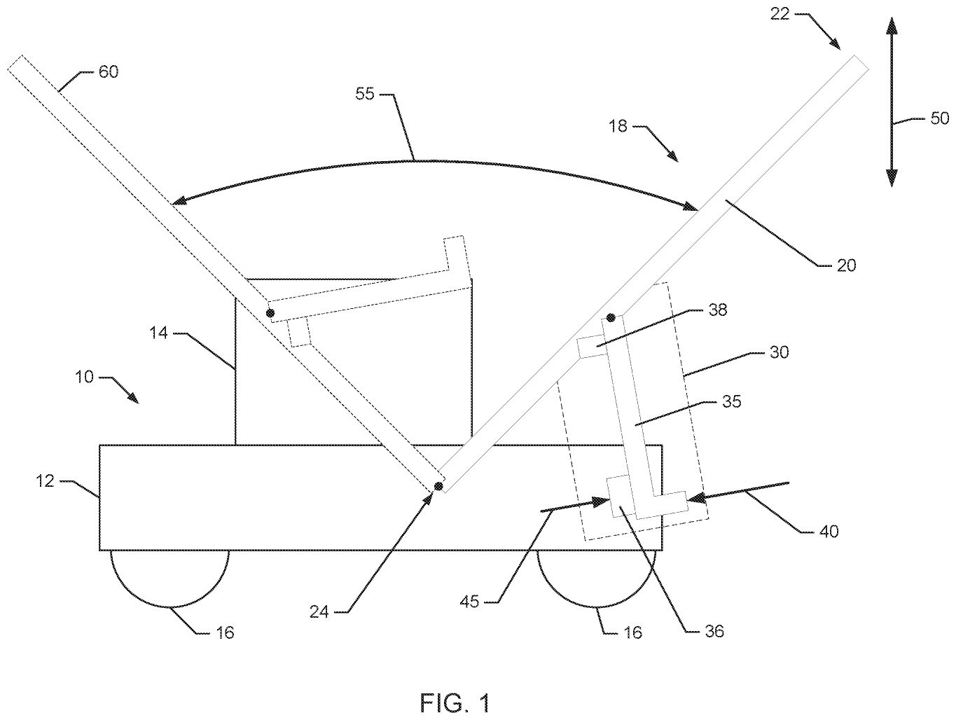

FIG. 1 illustrates a schematic view of a walk-behind lawn mower 10 of an example embodiment. An operator may be located at an operator location behind the lawn mower 10. The lawn mower 10 of FIG. 1 includes a blade housing 12 that may house a rotatable cutting blade (not shown). The cutting blade may be suspended above the ground at the end of a rotatable shaft (e.g., a drive shaft—again not shown) that may be turned responsive to operation of an engine 14, such as a gasoline powered engine or an electric motor. Operation of the engine 14 may be initiated by a recoil starter via pulling of a recoil starter handle by the operator. However, in other embodiments, the engine 14 may alternatively be started via a key, switch, electronic ignition or other similar device.

The lawn mower 10 may include a mobility assembly on which a substantial portion of the weight of the lawn mower 10 may rest when the lawn mower 10 is stationary. The mobility assembly may also provide for movement of the lawn mower 10. In some cases, the mobility assembly may be driven via power from the engine 14 that may be selectively provided to ground engaging wheels 16, which make up the mobility assembly.

In some examples, the ground engaging wheels 16 may be adjustable in their respective heights. Adjusting the height of the front wheels and/or the back wheels may be employed in order to provide a level cut and/or to adjust the height of the cutting blade. In some embodiments, a local wheel height adjuster may be provided at the front wheels and/or the back wheels. However, in other embodiments, remote wheel height adjustment may also or alternatively be possible.

In an example embodiment, the blade housing 12 and/or other portions of the lawn mower 10 that form a framework or structural platform upon which the components of the lawn mower 10 are assembled may be stamped, molded, welded, secured or otherwise assembled together to define a rugged and durable structure. The blade housing 12 may be a single or unitary structure, or may have various additional portions or components attached thereto. Thus, the blade housing 12 may generally be a body portion of the lawn mower 10 to which various other structural and functional components may be mounted.

In an example embodiment, the lawn mower 10 may further include a handle assembly 18. The handle assembly 18 may include at least one handle member 20 that extends generally rearward and upward from a rear portion of the blade housing 12 (or body portion). In some cases, the handle assembly 18 may include two handle members 20. In such cases, the handle members 20 may be substantially parallel to each other and may be connected to each other at their distal ends via a cross bar. The cross bar may be at a distal end 22 of the handle members 20. A proximal end 24 of the handle members 20 may engage or otherwise be operably coupled to the lawn mower 10 (e.g., to the blade housing 12). Thus, the terms distal and proximal should be understood to be used in reference to the blade housing 12 or engine 14 of the lawn mower 10.

The handle members 20 may be adjustable in height or may be foldable to reduce the amount of space that the lawn mower 10 consumes when stored or shipped via operation of a handle height adjustment assembly (HHAA) 30. As shown in FIG. 1, the HHAA 30 may be provided at a rear portion of the blade housing 12 (e.g., proximate to the rear wheels). A foot operated actuator 35 may be provided between the rear wheels (or proximate to one or the other of the rear wheels) and may be pivotally operably coupled to the handle assembly 18. In some cases, the HHAA 30 may further include a position keeper 36, a channel, and a positioning guide 38. In some embodiments, the foot operated actuator 35 may be operably coupled to the blade housing 12 via the channel, which may also be disposed at the rear portion of the blade housing 12. In this regard, the HHAA 30 may be disposed proximate to an operator, and the operator may easily apply a force on the foot operated actuator 35 in the forward and/or down direction identified by arrow 40. This force may act against a biasing force provided by the position keeper 36, which may be directed rearward and/or up as identified by arrow 45, and may keep the foot operated actuator 35 retained in a locked state in the channel. Responsive to the force applied by the operator in the direction of arrow 40, the HHAA 30 may enter an unlocked state where the handle assembly 18 may be free to move up or down in the directions indicated by arrow 50, or to rotate in the direction of arrow 55 into a folded position 60 when the force applied in the direction of arrow 40 exceeds the biasing force applied by the position keeper 36 in the direction of arrow 45. Responsive to the handle assembly 18 rotating in the direction of arrow 55 into the folded position 60, the foot operated actuator 35 may exit the channel and may accordingly rest on the positioning guide 38. Inversely, responsive to the handle assembly 18 rotating back towards the rear of the lawn mower 10 out of the folded position 60, the positioning guide 38 may ensure that the foot operated actuator 35 may properly reenter the channel. Further details about the HHAA 30 and its components will be described below in reference to later figures.

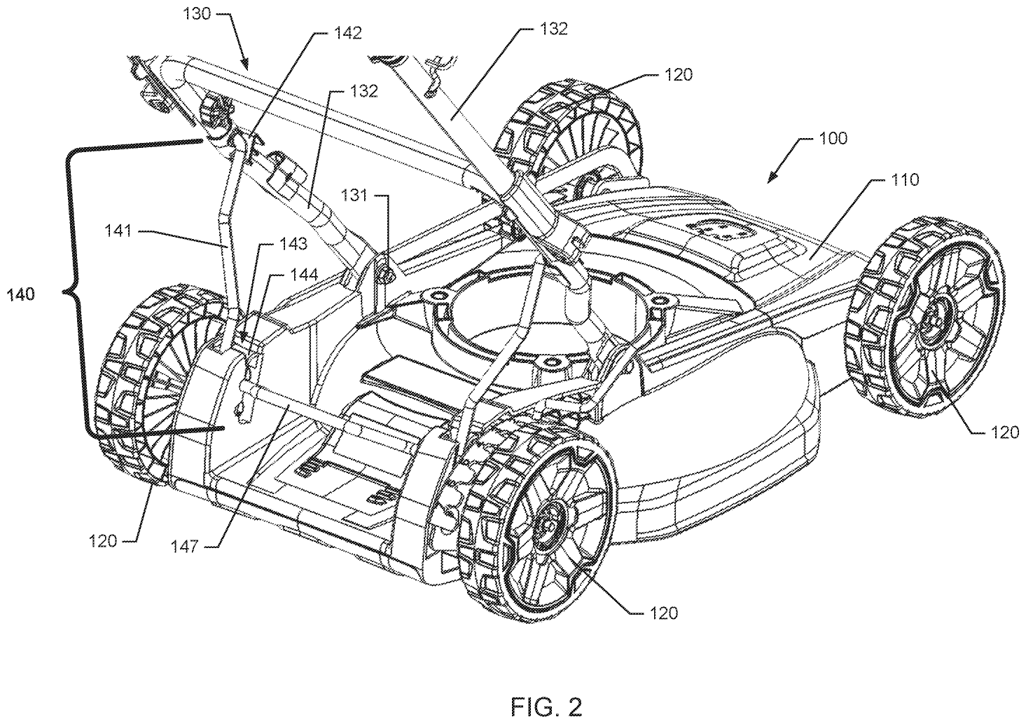

FIG. 2 depicts a lawn mower 100 according to an example embodiment. The lawn mower 100 depicted in FIG. 2 may be an example embodiment of the lawn mower 10 depicted in FIG. 1. As described above, the lawn mower 100 may include a blade housing 110, an engine (not shown), wheels 120, a handle assembly 130, and a handle height adjustment assembly (HHAA) 140. The HHAA 140 may be operable to allow the operator to select one of at least two different operating positions of the handle assembly 130. Each different operating position may correspond to a different handle height for the handle assembly 130. The handle assembly 130 may include at least one handle member 132 and in some cases, such as the embodiment shown in FIG. 2, two handle members 132. In FIGS. 2-6, the HHAA 140 and thus the handle assembly 130 are shown in a first operating position among the at least two different selectable operating positions (e.g., at a higher handle height). However, a second operating position with a lower handle height may also exist. Additionally, in the folded position 60, the handle assembly 130 may fold fully forward in order to minimize the amount of space that the lawn mower 100 occupies for storage or shipping. It should be appreciated that additional positions could also be defined in some alternative example embodiments.

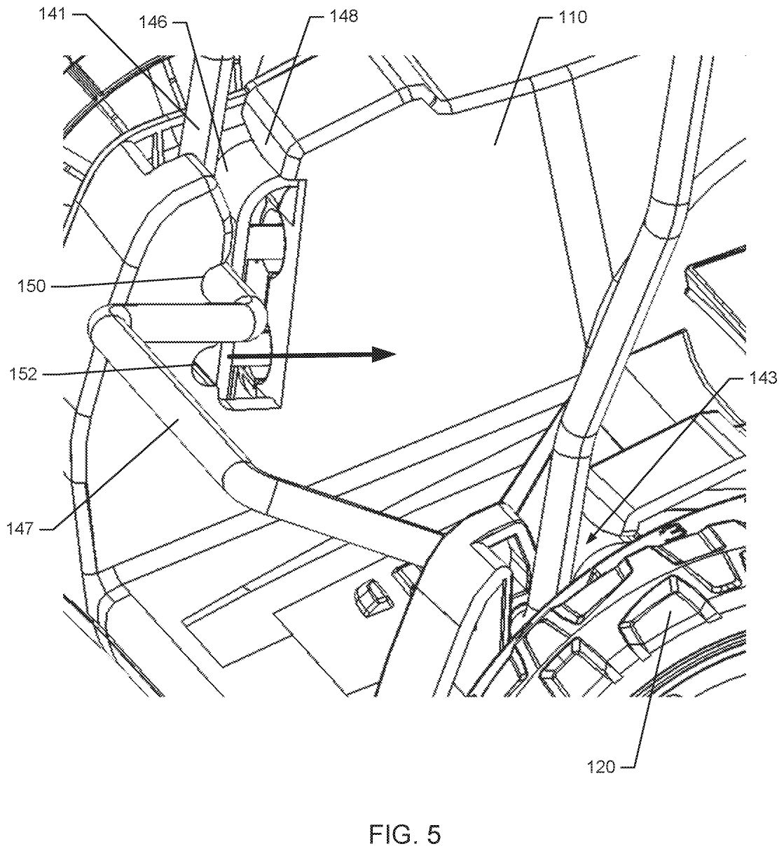

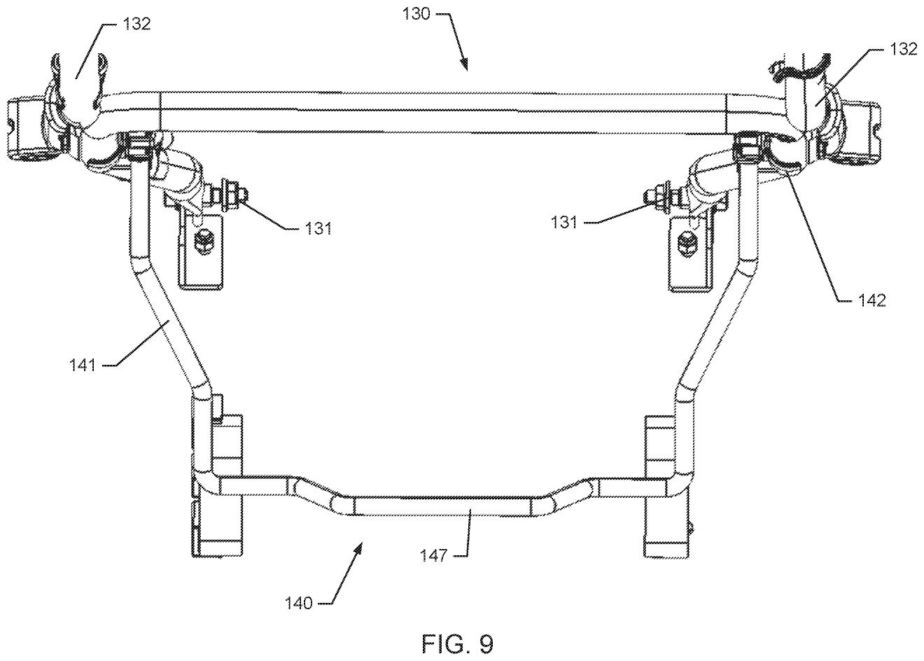

As briefly described above, the HHAA 140 may include a foot operated actuator 141, at least one positioning guide 142, at least one channel 143, and at least one position keeper 144. In some embodiments, such as the one depicted in FIGS. 2-10, the foot operated actuator 141 may be a rod assembly. In this regard, the foot operated actuator 141 may be a singular rod made of metal or any other suitable material capable of retaining its shape while receiving and transferring applied forces. The rod assembly may be bent or otherwise formed into a substantially horizontally bottomed “U” shape. As shown best in FIGS. 5 and 9, at the center of the horizontal bottom of the “U” shape, the foot operated actuator 141 may include a bump-out portion 147 that may make the foot operated actuator 141 accessible from the operator's positon behind the lawn mower 100. In this regard, the bump-out portion 147 may stick out beyond the blade housing 110 or body portion at the rear of the lawn mower 100 and extend towards the operator. Each upper end of the “U” shape of the foot operated actuator 141 may be pivotally operably coupled to respective ones of the handle members 132 via the positioning guides 142. In this regard, each positioning guide 142 may be operably coupled to the handle member 132 and may also include an orifice to which the rod assembly may pivotally operably couple. As such, the foot operated actuator 141 may be capable of pivoting relative to the handle member 132 to which it is operably coupled via the positioning guide 142. Additionally, the positioning guide 142 may restrict the range of the pivoting of the foot operated actuator 141 relative to the handle member 132, such that the foot operated actuator 141 may remain substantially aligned with the channel 143 after the foot operated actuator 141 is removed from the channel 143 for forward folding. By restricting the range of motion of the foot operated actuator 141 in this way, the positioning guide 142 may assist the foot operated actuator 141 in reentering the channel 143 when rotating the handle assembly 130 out of the folded position 60 in which the handle assembly 130 is folded fully forward. In this regard, the foot operated actuator 141 may automatically align with the channel 143 because of the positioning guide 142, making the re-installation of the HHAA 140 simpler, and preventing the foot operated actuator 141 from sloppily moving around during rotation of the handle assembly 130. More details about the positioning guide 142 will be discussed below in reference to later figures.

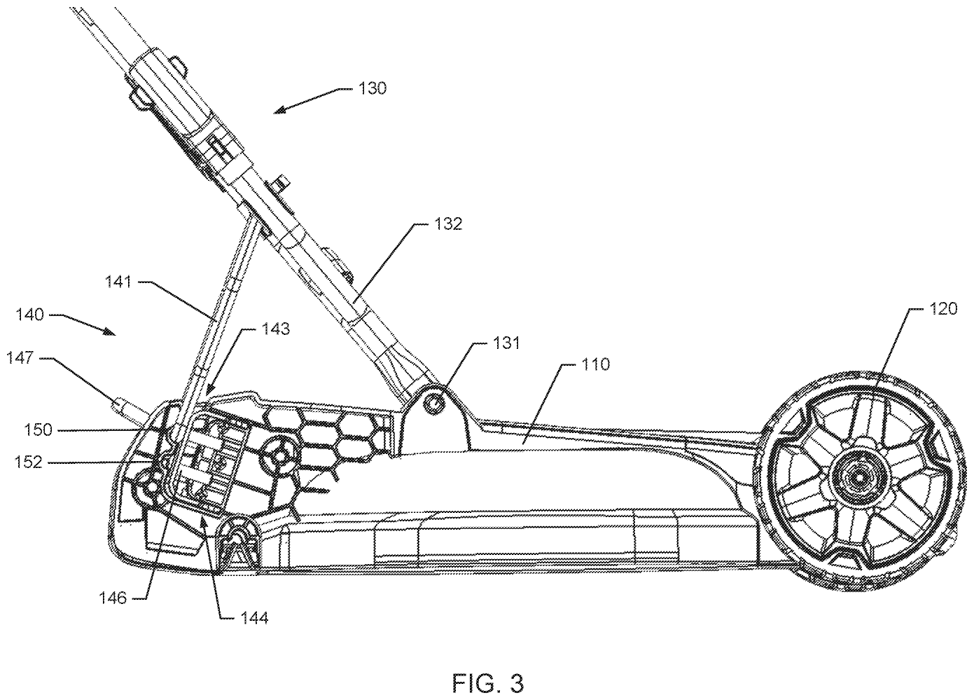

As depicted in FIGS. 2 and 3, the at least one channel 143 may be formed in the blade housing 110 (or a structure operably coupled thereto) near a location at which the foot operated actuator 141 extends down from the handle members 132 as restricted by the positioning guide 142. The embodiment depicted in FIGS. 2 and 3 may include two channels 143, with respective ones of the channels 143 disposed proximate to rear end corners of the blade housing 110 and, in this example, also proximate to the rear wheels 120. In some cases, the channels 143 may each be identical to one another (e.g., mirroring each other with respect to a longitudinal centerline of the lawn mower 100) to enhance the ease of operation of the foot operated actuator 141. In an example embodiment, the channels 143 may include a first slot 150 and a second slot 152 (and potentially other slots as well in some cases). The first and second slots (150. 152) may correspond to the first and second operating positions of the handle assembly 130, respectively. In this regard, the foot operated actuator 141 may be retained in either of the first or second slots (150, 152) when in the locked state. For example, responsive to the foot operated actuator 141 being retained in the first slot 150, the handle assembly 130 may be in the first operating position which may correspond to a higher operating position for the handle assembly 130. Conversely, responsive to the foot operated actuator 141 being retained in the second slot 152, the handle assembly 130 may be in the second operating position which may correspond to a lower operating position for the handle assembly 130. If other slots are employed, each slot will correspond to a respective different operating position or handle height.

In each of the possible handle positions, the HHAA 140 may be operated to shift between an unlocked state, which allows the handle members 132 to be rotated relative to the blade housing 110, and a locked state, which holds the handle members 132 in a corresponding desired position. In some embodiments, the HHAA 140 may be designed so that the foot operated actuator 141 may only be retained in the first slot 150 or the second slot 152 when the HHAA 140 is in the locked state. However, in order to shift between the first slot 150 and the second slot 152, the HHAA 140 must be in the unlocked state. Additionally, to shift from either of the first slot 150 or the second slot 152 to the folded position, the HHAA 140 must be in the unlocked state. Moreover, in some cases, the HHAA 140 may be biased (e.g. with spring force applied by the position keeper 144) toward the locked state so that the handle assembly 130 remains secured while the lawn mower 100 is in use.

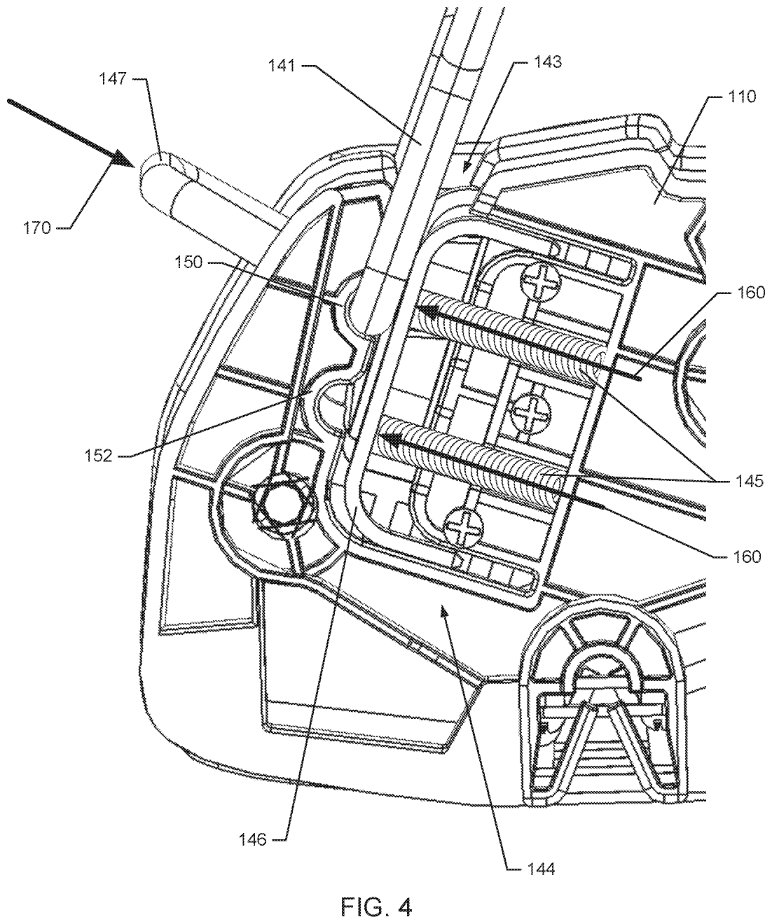

FIG. 3 shows a partial sectional side view of the lawn mower 100, and FIG. 4 shows a close-up view of the position keeper 144 from FIG. 3. The position keeper 144 may apply the biasing force to the foot operated actuator 141 that may keep the foot operated actuator 141 retained in the locked state in either of the first or second slots (150, 152). The position keeper 144 may include at least one biasing member 145 and a retention member 146. In an example embodiment, the retention member 146 may be urged by the biasing member 145 to act on the foot operated actuator 141 in a first direction to bias the foot operated actuator 141 into the locked state in either of the first or second slots (150, 152). As mentioned previously with respect to FIG. 1, the biasing force of the position keeper 144 may act rearward and up, or in other words, substantially normal to a direction of extension of the channel 143. Thus, the force applied by the operator in order to shift the foot operated actuator 141 into the unlocked state may oppose the biasing force of the position keeper 144 (i.e. forward and down).

FIG. 4 shows a different view in which the motion of the position keeper 144 may be appreciated. In this regard, the position keeper 144 is depicted retaining the HHAA 140 in the locked state in the first slot 150 by exerting a biasing force in the direction of arrow 160 from the biasing members 145. As such, in order to get the HHAA 140 to enter the unlocked state, a force may be applied by the operator to the foot operated actuator 141 in the direction of arrow 170. Responsive to the force in the direction of arrow 170 overcoming the force in the direction of arrow 160, the HHAA 140 may enter the unlocked state. While maintaining the force on the foot operated actuator 141 in the direction of arrow 170, the handle assembly 130 may be lowered such that the foot operated actuator 141 aligns with the second slot 152, or the handle assembly 130 may also be rotated forward into the storage position such that the foot operated actuator 141 exits the channel 143 upward. If the handle assembly 130 is lowered into the second slot 152, then the operator simply has to stop applying the force in the direction of arrow 170, and the position keeper 144 may bias the foot operated actuator 141 into the second slot 152 and thus back into the locked state. In some embodiments, the retention member 146 of the position keeper 144 may be substantially “U” shaped as well. In this regard, the retention member 146 may include a planar surface at the base of the “U” that extends for a length that is roughly equivalent to the depth of the channel 143. At each end of the planar surface, the planar surface my curve back away from the channel 143 and substantially perpendicular to the planar surface, and form the upright portions of the “U” shape. These perpendicular portions of the planar surface may help keep the retention member 146 in position, and may be slidably operably coupled with the blade housing 110. Furthermore, in the embodiment of FIG. 4, the retention member 146 may also be operably coupled to two biasing members 145. The biasing members 145 may reside in respective bores formed within the blade housing 110 which may be angled to determine the direction of the biasing force applied by the position keeper 144. In some cases, the biasing member 145 may be a spring.

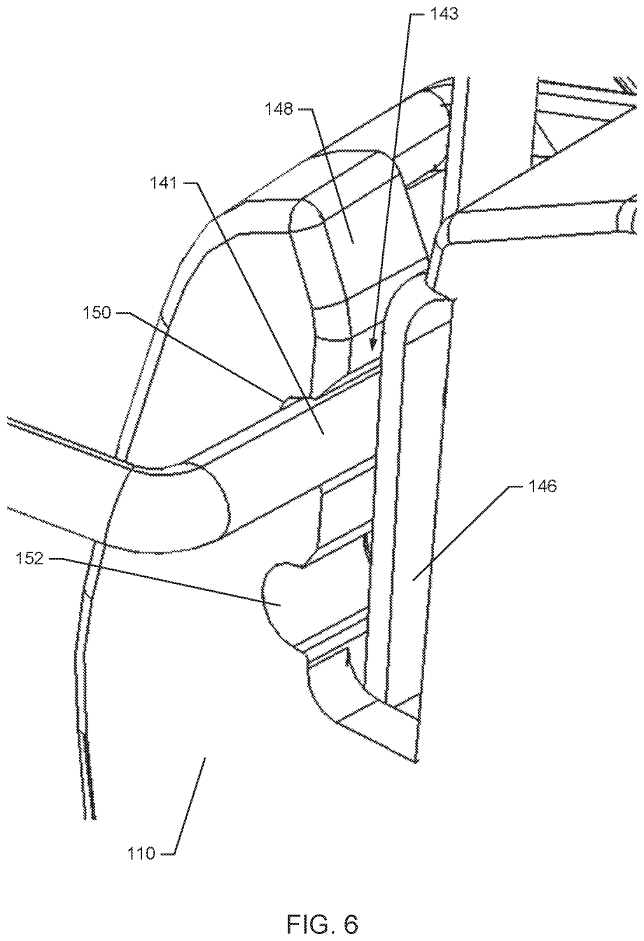

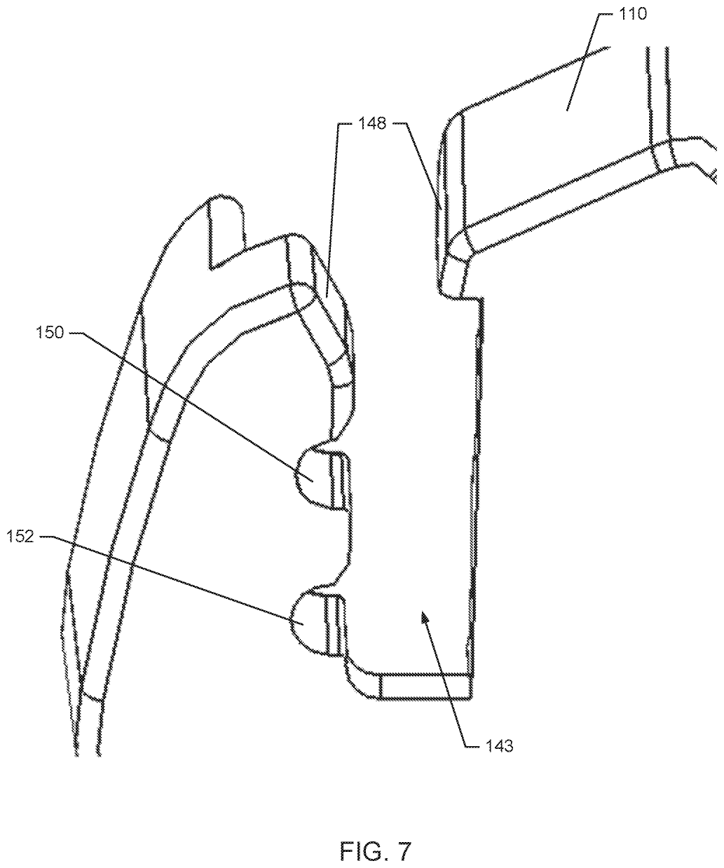

FIGS. 5 and 6 depict close up perspective views of the rear portion of the lawn mower 100, and FIG. 7 depicts a close up side view of the channel 143. These figures help to further detail the shapes of both the channel 143 and the foot operated actuator 141. The foot operated actuator 141 may be shaped such that vertical portions of the foot operated actuator 141 meet the horizontal bottom portion of the foot operated actuator 141 at an exterior side of the channel 143 and the blade housing 110. In this regard, the horizontal bottom portion of the foot operated actuator 141 may be the part of the foot operated actuator 141 that interacts with the channel 143 and accordingly with the first and second slots (150, 152). FIGS. 5 and 6 also show the retention member 146 and how the planar surface curves perpendicularly away from the channel 143 and into the blade housing 110. This, along with the biasing members 145, may be what keeps the retention member 146 in proper orientation within the channel 143. Additionally, FIGS. 5, 6, and 7 show the entryway to the channel 143. While the channel 143 itself may be substantially rectangular, the entryway to the channel 143 may comprise one or more sloped or slanted surfaces 148 such that the sloped or slanted surface 148 leads into the channel 143. Thus, for example, the one or more sloped or slanted surfaces 148 will tend to guide the foot operated actuator 141 into the channel 143 when the handle assembly 130 is folded back towards the rear of the lawn mower 100. This, along with the positioning guides 142, may help ensure that the foot operated actuator 141 can easily reenter the channel after being removed from the channel 143, potentially as a result of the handle assembly 130 being folded forward into the folded position 60.

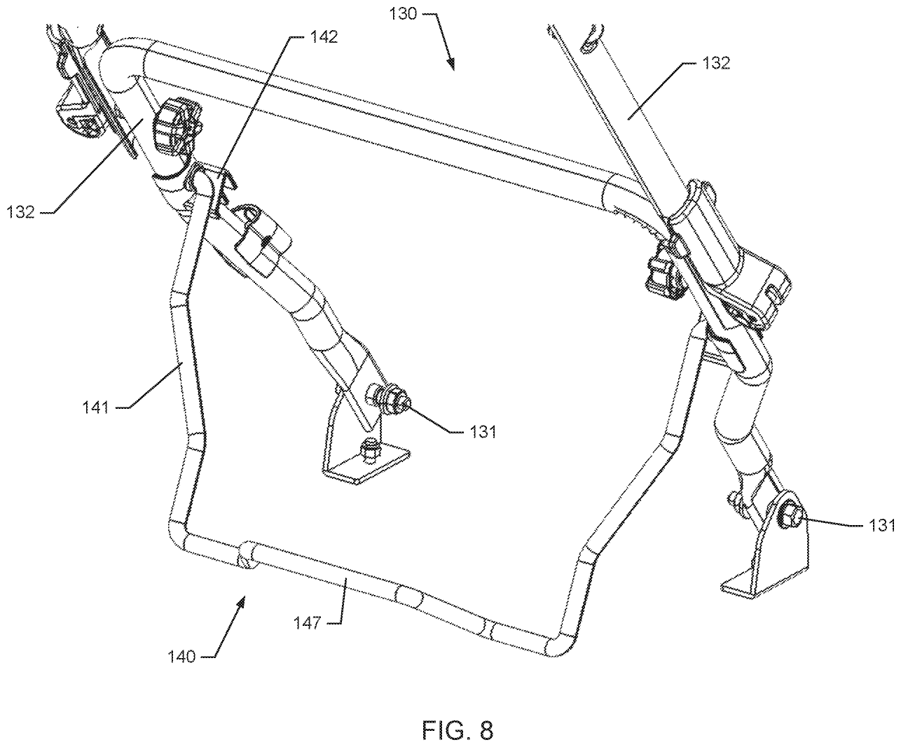

FIGS. 8 and 9 depict the HHAA 140 and the handle assembly 130 isolated from the blade housing 110. In this regard, these figures may provide a better sense for the sizes of the HHAA 140 and the handle assembly 130, respectively. The foot operated actuator 141 may be operably coupled to the handle assembly 130 at a location disposed a distance away from a pivot point 131 of the handle assembly 130 relative to the blade housing 110 that is roughly equivalent to the height of the foot operated actuator 141. In other words, if the handle assembly 130 and the foot operated actuator 141 were both put into a vertical orientation such that they formed a right angle with the blade housing 110, the horizontal bottom portion of the foot operated actuator 141 may accordingly be disposed at the pivot point 131 of the handle assembly 130 and the blade housing 110. However, in some embodiments, the foot operated actuator 141 may be prevented from forming a right angle with the blade housing 110 by the positioning guide 142. The bump-out portion 147 of the foot operated actuator 141 is further visible in FIG. 9. As mentioned above, this portion of the foot operated actuator 141 may improve the ease of access to the HHAA 140 for the operator of the lawn mower 100 by extending the foot operated actuator 141 out beyond the end of the blade housing 110 as depicted in FIGS. 3-5.

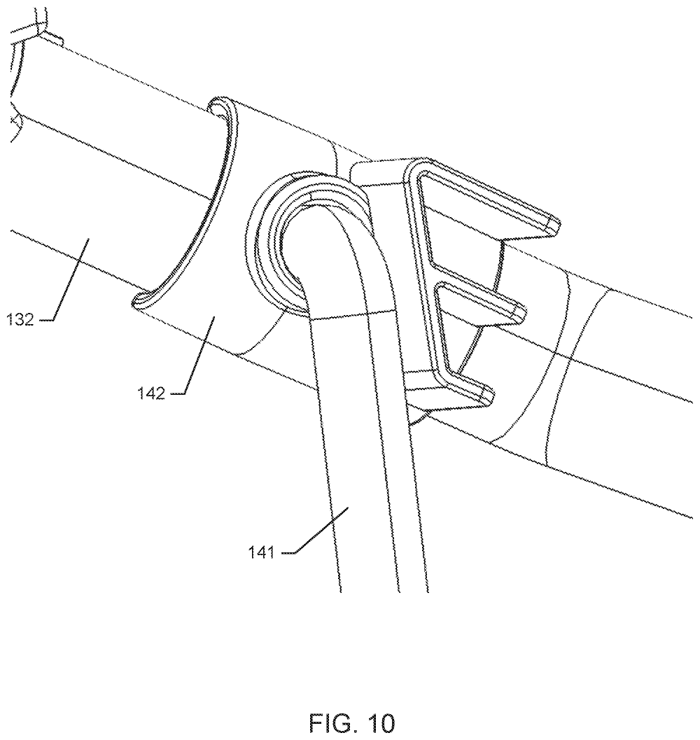

FIG. 10 shows a close up view of the positioning guide 142. As mentioned above, the positioning guide 142 may operably couple the foot operated actuator 141 to the handle assembly 130 at a distance away from the pivot point 131 that is roughly equal to the height of the foot operated actuator 141. The positioning guide 142 may clasp onto the handle member 132 and may include an orifice for the foot operated actuator 141 to pivotally operably couple with. In this regard, the foot operated actuator 141 may pivot relative to the handle member 132 within a predetermined range of motion determined by the positioning guide 142. Accordingly, in some cases, the positioning guide 142 further comprises a planar face that may be formed at an angle relative to the rest of the positioning guide 142. The planar face may serve to support the foot operated actuator 141 in the event that the handle assembly 130 is folded forward such that the foot operated actuator 141 exits the channel 143 (e.g. when the handle assembly 130 is folded into the storage position). In this case, the planar face of the positioning guide 142 may support the foot operated actuator 141 at the proper orientation for reentering the channel 143 responsive to the handle assembly 130 being folded back to either of the first or second operating positions.

Some example embodiments may provide for a lawn mower. The lawn mower may include a blade housing configured to house at least one blade, an engine supported at least in part by the blade housing to selectively rotate the at least one blade, a handle assembly operably coupled to the blade housing, and a handle height adjustment assembly (HHAA) which may include a foot operated actuator operably coupled to the at least one handle member. The handle assembly may include at least one handle member for guiding operation of the lawn mower by an operator walking substantially behind the lawn mower. The foot operated actuator may be operably coupled to the at least one handle member at a portion of the at least one handle member that is spaced apart from a pivot point of the handle assembly relative to the blade housing. The HHAA may be configured to enable the at least one handle member to be fixed in at least a first operating position or a second operating position, each operating position defining different handle heights for the at least one handle member responsive to the HHAA being in a locked state. The HHAA may be further configured to enable the at least one handle member to be rotated between the first operating position, the second operating position, and a folded position responsive to the HHAA being in an unlocked state.

The lawn mower of some embodiments may include additional features, modifications, augmentations and/or the like to achieve further objectives or enhance performance of the lawn mower. The additional features, modifications, augmentations and/or the like may be added in any combination with each other. Below is a list of various additional features, modifications, and augmentations that can each be added individually or in any combination with each other. For example, the HHAA may further include a channel formed in or operably coupled to a rear portion of the blade housing. In an example embodiment, the channel may have slots disposed at respective different locations in the channel that may correspond to the different handle heights. In some cases, the HHAA may further include a position keeper disposed proximate to the channel to retain the foot operated actuator in one of the slots. In an example embodiment, the position keeper may include a biasing member and a retention member. In some cases, the retention member may be urged by the biasing member to act on the foot operated actuator in a first direction normal to a direction of extension of the channel. In an example embodiment, the first direction may generally be a rearward and up direction relative to a front of the lawn mower. In some cases, the operator may exert a force on the foot operated actuator generally in a forward and down direction to overcome the biasing member to transition from the locked state to the unlocked state. In an example embodiment, the channel may further include at least one sloped surface that may form an entryway to enable the foot operated actuator to enter the channel responsive to the at least one handle member rotating from the folded position to either of the first or second operating positions. In some cases, the foot operated actuator may be a rod assembly pivotally operably coupled to the at least one handle member. In an example embodiment, the HHAA may further include a positioning guide operably coupled to the at least one handle member and to the rod assembly which may restrict movement of the rod assembly to a range of positions that may align with the at least one sloped surface at the entryway of the channel. In some cases, the handle member may be spaced apart from a pivot point of the handle assembly relative to the blade housing by a distance that may be roughly equal to the length of the rod assembly extending away from the at least one handle member. In an example embodiment, the rod assembly may be in the channel when the at least one handle member may be in the first and second operating positions. In some cases, the rod assembly may be out of the channel when the at least one handle member may be in the folded position.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A lawn mower comprising:
a blade housing configured to house at least one blade;
an engine supported at least in part by the blade housing to selectively rotate the at least one blade;
a handle assembly operably coupled to the blade housing, the handle assembly comprising at least one handle member for guiding operation of the lawn mower by an operator walking substantially behind the lawn mower; and
a handle height adjustment assembly (HHAA) comprising a foot operated actuator operably coupled to the at least one handle member at a portion of the at least one handle member that is spaced apart from a pivot point of the handle assembly relative to the blade housing,
wherein the HHAA is configured to enable the at least one handle member to be fixed in at least a first operating position or a second operating position each defining different handle heights for the at least one handle member responsive to the HHAA being in a locked state, and
wherein the HHAA is further configured to enable the at least one handle member to be rotated between the first operating position, the second operating position, and a folded position responsive to the HHAA being in an unlocked state.

2. The lawn mower of claim 1, wherein the HHAA further comprises a channel formed in or operably coupled to a rear portion of the blade housing, the channel having slots disposed at respective different locations in the channel corresponding to the different handle heights.

3. The lawn mower of claim 2, wherein the HHAA further comprises a position keeper disposed proximate to the channel to retain the foot operated actuator operably coupled to one of the slots.

4. The lawn mower of claim 3, wherein the position keeper comprises a biasing member and a retention member, the retention member being urged by the biasing member to act on the foot operated actuator in a first direction normal to a direction of extension of the channel.

5. The lawn mower of claim 4, wherein the first direction is generally a rearward and up direction relative to a front of the lawn mower, and wherein the operator exerts a force on the foot operated actuator generally in a forward and down direction to overcome the biasing member to transition from the locked state to the unlocked state.

6. The lawn mower of claim 2, wherein the channel further comprises at least one sloped surface forming an entryway to enable the foot operated actuator to enter the channel responsive to the at least one handle member rotating from the folded position to either of the first or second operating positions.

7. The lawn mower of claim 6, wherein the foot operated actuator is a rod assembly pivotally operably coupled to the at least one handle member.

8. The lawn mower of claim 7, wherein the HHAA further comprises a positioning guide operably coupling the at least one handle member to the rod assembly, wherein the positioning guide restricts movement of the rod assembly to a range of positions that align with the at least one sloped surface at the entryway of the channel.

9. The lawn mower of claim 7, wherein the handle member is spaced apart from a pivot point of the handle assembly relative to the blade housing by a distance that is roughly equal to a length of the rod assembly extending away from the at least one handle member.

10. The lawn mower of claim 7, wherein the rod assembly is in the channel when the at least one handle member is in the first and second operating positions, and out of the channel when the at least one handle member is in the folded position.

11. A handle height adjustment assembly for adjusting a height of at least one handle member of a walk-behind lawn mower, the assembly comprising:
a foot operated actuator operably coupled to the at least one handle member at a portion of the at least one handle member that is spaced apart from a pivot point of the at least one handle member relative to the blade housing,
wherein the assembly is configured to enable the at least one handle member to be fixed in at least a first operating position or a second operating position each defining different handle heights for the at least one handle member responsive to the assembly being in a locked state, and
wherein the assembly is further configured to enable the at least one handle member to be rotated between the first operating position, the second operating position, and a folded position responsive to the assembly being in an unlocked state.

12. The assembly of claim 11, further comprising a channel formed in or operably coupled to a rear portion of the blade housing, the channel having slots disposed at respective different locations in the channel corresponding to the different handle heights.

13. The assembly of claim 12, further comprising a position keeper disposed proximate to the channel to retain the foot operated actuator in one of the slots.

14. The assembly of claim 13, wherein the position keeper comprises a biasing member and a retention member, the retention member being urged by the biasing member to act on the foot operated actuator in a first direction normal to a direction of extension of the channel.

15. The assembly of claim 14, wherein the first direction is generally a rearward and up direction relative to a front of the lawn mower, and wherein the operator exerts a force on the foot operated actuator generally in a forward and down direction to overcome the biasing member to transition from the locked state to the unlocked state.

16. The assembly of claim 12, wherein the channel further comprises at least one sloped surface forming an entryway to enable the foot operated actuator to enter the channel responsive to the at least one handle member rotating from the folded position to either of the first or second operating positions.

17. The assembly of claim 16, wherein the foot operated actuator is a rod assembly pivotally operably coupled to the at least one handle member.

18. The assembly of claim 17, further comprising a positioning guide operably coupling the at least one handle member to the rod assembly, wherein the positioning guide restricts movement of the rod assembly to a range of positions that align with the at least one sloped surface at the entryway of the channel.

19. The assembly of claim 17, wherein the handle member is spaced apart from a pivot point of the handle assembly relative to the blade housing by a distance that is roughly equal to a length of the rod assembly extending away from the at least one handle member.

20. The assembly of claim 17, wherein the rod assembly is in the channel when the at least one handle member is in the first and second operating positions, and out of the channel when the at least one handle member is in the folded position.
